(19) United States
(12) Patent Application Publication
(10) Pub. No.: US 2018/0010741 A1
(43) Pub. Date: Jan. 11, 2018

(54) Light emitting flat flash light with a 1 degree lens collimator

(71) Applicant: Mike Barnes, Dunnellon, FL (US)

(72) Inventor: Mike Barnes, Dunnellon, FL (US)

(21) Appl. No.: 14/999,846

(22) Filed: Jul. 11, 2016

(51) Int. Cl. F21L 4/02; F21L 4/00; F21L 4/08; G02B 27/30; F21V 23/04

(52) U.S. Cl. CPC F21L 4/027; G02B 27/30; F21V 23/0414; F21V 23/0407; F21L 4/085; F21L 4/005; F21Y 2115/10

(57) ABSTRACT

The hand held flat flash light about the size of a cell phone with a 1 degree lens collimator, a rechargeable battery contained in the body, an on/off switch and one or more LED's that emit a high energy beam of light or spot light.

### BACKGROUND OF THE INVENTION

The present invention relates generally to a more readily available flash light that can be carried in the shirt pocket.

Typically, in law enforcement when the patrol officer is outside his car at night and doesn't have his flash light with him it would be convenient to have an auxiliary substitute flash light that could be carried in the shirt pocket. It would be desirable to provide a flat flash light that would fit in the shirt pocket that has a powerful beam of light such as a spot light.

It would therefore be desirable to provide a high bright beam flash light that would be more accessible to the user by storing it in the shirt pocket.

### SUMMARY OF INVENTION

Aspects of the present invention are obviously advantageous to everyone that may use or need a flash light.

In accordance with one aspect of the invention, a hand held flash light about the size of a cell phone with a 1 degree lens collimator, a battery compartment, a rechargeable battery, an on/off switch and one or more high power LED's that emit light. The flash light could have a strobe light and an S.O.S. function.

Accordingly, the flash light is turned on by depressing the switch which turns on the LED/LED's.

Furthermore, aspects of the invention are illustrated in the remainder of this disclosure of the invention.

### BRIEF DESCRIPTION OF THE DRAWINGS

The drawings should be understood to present an illustration of various aspects of the invention and/or principles involved, and not to limit the scope of the subject matter as set forth in the claims.

The present invention relates to a hand held device that emits light. Furthermore, aspects of the invention are illustrated in the remainder of this disclosure with reference to a flat pocket sized flash light about the size of a cell phone.

The light emitting device could be used by anyone in need of a convenient easily accessed flash light.

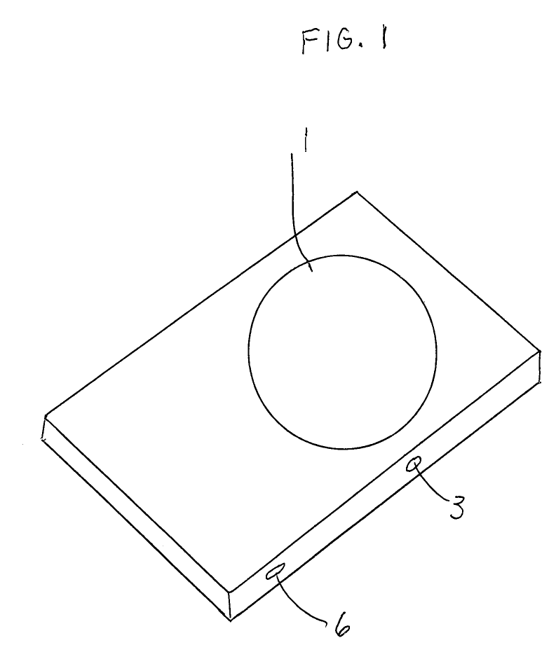

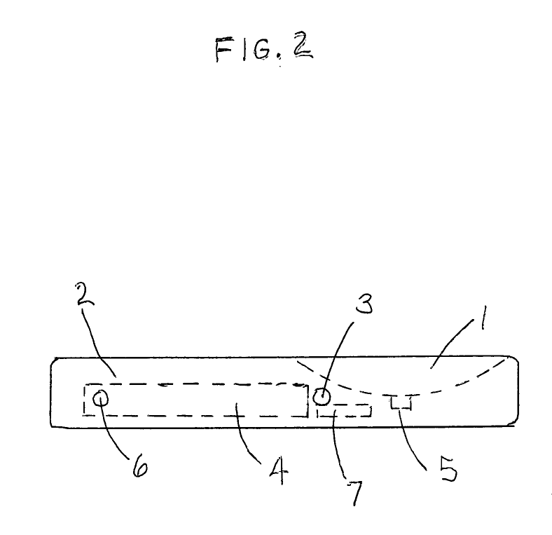

The representative flat flash light that emits high energy light as illustrated in FIGS. 1 and 2 has a 1 degree lens collimator 1 and a battery compartment 2, an on/off switch 3, a rechargeable battery 4, an LED 5, a charging port 6 and a PCB 7.

Although preferred embodiments of the invention have been disclosed, it should be understood that various changes, modifications and substitutions may be incorporated in the embodiment without departing from the spirit of the invention, which is defined by the following claims.

Certain modifications and improvements will occur to those skilled in the art upon reading the foregoing description. It should be understood that all such modifications and improvements have been omitted for the sake of conciseness and readability, but are properly within the scope of the following claims.

What is claimed is:

1. A light emitting flat flash light comprising:
a 1 degree lens collimator, a battery compartment, a rechargeable battery, an LED or plurality of LED's,
whereby a person who uses the flat flash light can store it in the shirt pocket.

2. The light emitting flat flash light of claim 1, characterized by a mechanical on/off switch.

3. The light emitting flat flash light of claim 2, wherein the on/off switch turns the LED or LED's on and off and operable by the user.

4. The light emitting flat flash light of claim 3, characterized by using a flat 1 degree lens collimator that emits a high energy light beam.

5. The light emitting flat flash light of claim 4, with a strobe light mode.

6. The light emitting flat flash light of claim 3, powered by a rechargeable battery.

7. The light emitting flat flash light of claim 1 powered by a disposable battery.
